(19) United States
(12) Patent Application Publication
(10) Pub. No.: US 2017/0145202 A1
(43) Pub. Date: May 25, 2017

(54) METHOD, APPARATUS AND FORMULATION FOR AN INTERPENETRATING NETWORK POLYMER

(71) Applicant: Miami University, Oxford, OH (US)

(72) Inventors: Jessica L. Sparks, Oxford, OH (US); Martha M. Fitzgerald, Hilliard, OH (US); Jason Berberich, Oxford, OH (US)

(21) Appl. No.: 15/295,636

(22) Filed: Oct. 17, 2016

Related U.S. Application Data
(60) Provisional application No. 62/242,490, filed on Oct. 16, 2015.

(51) Int. Cl. C08L 33/26; B29B 7/32; B33Y 30/00; B33Y 70/00; B29C 67/00; B33Y 10/00

(52) U.S. Cl. CPC C08L 33/26; B29C 67/007; B29C 67/0092; B33Y 10/00; B33Y 30/00; B33Y 70/00; B29B 7/325; B29K 2105/0061

(57) ABSTRACT

An alginate-polyacrylamide IPN hydrogel formulation for 3D printing using a dual syringe system where the components that initiate polymerization of each network remain separated until printing. The dual syringe system may use a single motor and mixing head to combine both parts of the hydrogel formulation for controlled polymerization of the material. The elastic and time-dependent viscoelastic properties (stress relaxation) are tuned to match mammalian tissues by changing the crosslink density and monomer concentration. The fracture energy of the material may be increased by soaking in a calcium chloride solution. The resulting IPN polymer material may find application in soft tissue medical simulation devices, particularly because the mechanical properties may be tuned to mimic the elastic and viscoelastic properties of muscle tissue and may be 3D printed in the shape of anatomical parts.

### BACKGROUND OF THE INVENTION

The invention relates generally to the field of polymer formation, and more specifically to processes of forming interpenetrating network (IPN) polymer materials, formulations used to make such materials, and apparatuses for forming such materials.

Costs associated with medical errors have been estimated at about $17 billion per year. Medical simulation, which allows physicians to practice a procedure repeatedly using simulators that have realistic mechanical and geometrical properties, is an important strategy for reducing these injurious and costly errors. There is a need for advanced biomechanically realistic tissue analogue materials for use in medical simulators. Such materials are commonly made from hydrogels, because hydrogels simulate human tissue well. The ability to create a medical simulator component that is prepared from materials that have the required properties, such as proper anatomical shape and haptic feedback, could reduce costs, speed simulator manufacturing, and make advanced tissue mimetic models more widely available.

3D printing is a process used to form three-dimensional objects in which successive, thin layers of material are formed under computer control. The manufacture of medical simulator components using 3D printing has been contemplated, but 3D printing of hydrogel materials has obstacles to successful implementation. Hydrogel 3D printing methods known to Applicants involve extrusion of a single network hydrogel solution. In order to print more complex hydrogel materials, such as IPN, dual network, or other multi-component gels on the 3D printer platform, a different approach must be used. For example, a recent study developed a system that allows for two hydrogel materials to be printed through a single print-head using pressure variation. Another study reported 3D printing of an IPN gel with notable toughness properties.

IPN materials are composed of two or more distinct interpenetrating polymer networks where at least one of the networks has been cross-linked and/or synthesized in the presence of the other. The structure of an IPN imparts unique mechanical behavior to these materials. They can be shown to possess mechanical properties that exceed those of any of their component networks taken individually. These materials traditionally have been created by cross-linking the first polymer network, then soaking this network in a solution of monomers and/or cross-linkers and applying an appropriate input (e.g. UV light, heat) to initiate cross-linking of the second network in the presence of the first.

IPN hydrogels are promising materials for medical simulation and other applications because of their increased strength and ability to mimic both elastic and viscoelastic properties. However, little is known about the viscoelastic relaxation behavior of 3D printed IPN materials or how the viscoelastic properties may be controlled via the 3D printing process.

### BRIEF SUMMARY OF THE INVENTION

Disclosed herein are a method and an apparatus that may be used to create three dimensional constructs of IPN polymer materials, and formulations for IPN polymer materials.

The apparatus disclosed herein dispenses a fluent material that is formed into an IPN polymer material. The preferred such apparatus is a 3D printer that may form an IPN hydrogel material with tunable elastic and viscoelastic properties in the range of biological soft tissue. However, many mechanisms for precisely dispensing a liquid could substitute for the preferred apparatus. Any apparatus that combines and then dispenses two or more liquids from two or more separate containers would be suitable. For example, it is contemplated that a human user may dispense a liquid that is hand-squeezed from two or more syringes through a mixing head and out a single spout or nozzle. Such a liquid mixture may be dispensed onto a substrate with less precision than the 3D printer, but such an apparatus may be suitable under some circumstances. The human user may manually dispense the mixture in layers to form the three dimensional structure desired, and alternatively the human user may dispense the mixture into a mold or other shape-retaining structure. Furthermore, although the 3D printer described herein is relatively simple, a much more complex apparatus may be substituted which also has the basic structures that permit the components of the formulation to be separated, forced into a mixing structure to begin cross-linking at least one of the polymer networks of the IPN, and then irradiated or otherwise energized as the mixture is extruded from the nozzle onto a substrate.

The formulation of the present invention includes any two or more separate components that, when combined, begin to form at least one network of an IPN polymer material by cross-linking to form that first polymer network. The second or more polymer network cross-links under different circumstances than the first polymer network, and at least one of the second network's cross-linking is initiated by the application or removal of one or more external inputs. These external inputs may include the application of energy, such as heat and/or light (of a predetermined wavelength or another characteristic), or the presence of chemicals that are applied to the mixture, such as a catalyst or another reactant. This could include a chemical that is released by the polymerization of another polymer network. Each of the polymer networks of the IPN must be cross-linked and/or synthesized simultaneously, or at least substantially simultaneously. A formulation is a candidate if it can be separated into two or more containers, where the combination of the containers' contents is required to form at least a first one of the IPN polymer networks and the formation of at least a second of the polymer networks requires an external input. The preferred formulation is an alginate-polyacrylamide IPN hydrogel material that is divided into two orthogonal reactive mixture (ORM) solutions that are mixed prior to extrusion, as shown and described herein.

The method includes the steps of mixing two or more components together that will form an IPN, where the components are in separate containers to prevent contact. One network of the IPN begins to polymerize upon mixing of the two or more components, for example by a chemical reaction of reactants in the previously separate containers when injected into a static mixing head. Another network of the IPN begins to polymerize by the application of an external input. The external input may be ultraviolet (UV) light, and this is preferably applied to the mixture as it is extruded from a nozzle that is connected to the end of the mixing head. Thus, at least two polymer networks of the IPN polymer material are forming substantially simultaneously as the fluent material is being dispensed onto a substrate.

The method may be performed using a 3D printer having two or more syringes. In order to prevent premature cross-linking of either polymer network of the IPN, the reactive chemical components of the polymer networks are contained in the syringes that function as the separate containers and are connected to a receptacle, which may be a static mixing head on the print head of the 3D printer. The contents of the syringes are driven through the mixing head to initiate a chemical reaction between the reactive components. The mixture is subsequently extruded through a nozzle, which is mounted to the mixing head, exposed to UV light (or some other energy input) to initiate cross-linking of the second polymer network, and deposited to form the desired 3D shape. The deposition may be in layer-by-layer fashion in which a later extrusion, or a subsequently extruded portion of the same extrusion, is placed vertically above and upon a previously formed extrusion.

The invention may be used to create 3D constructs from a variety of polymeric materials. The mechanical properties of such constructs can be controlled by varying the chemical composition and/or printing parameters. The method, formulations and apparatuses disclosed herein may form an IPN polymer material, such as a hydrogel, and the elastic and viscoelastic properties thereof, which are preferably in the range of biological soft tissue, are tunable by formulation and/or the manner of forming the IPN polymer material. Some applications for the completed constructs include, without limitation, developing anatomical models for medical simulation and/or healthcare training; creating test materials for ballistics testing and/or injury biomechanics; drug delivery applications; cellular mechanosensitivity studies; artificial muscle; and tissue engineering applications, and others that will become apparent to the person of ordinary skill from the description herein. Additional applications outside the biomedical realm include 3D printing of a range of elastomeric materials, coatings, gaskets, and membranes. An IPN polymer material formed using the method, formulations and/or apparatus disclosed herein may be used for any purpose for which such materials are known to be used, or for which they are suitable.

Applicants' 3D printing process, formulations and apparatus allow the creation of IPN polymer materials in virtually any shape, and can create structures with more complex geometries than could previously be created, and with the potential for a hierarchical structure. For example, the path of the print nozzle can be programmed so that the polymer is deposited with fibers predominantly aligned in one direction, imparting anisotropic (direction-dependent) properties to the construct. This technology could be applied to create tissue engineering scaffolds with patient-specific geometries using IPN polymer materials.

Applicants have successfully 3D printed IPN polymer materials in the shapes and with the characteristics described herein. The formulations of the polymers used in the printed IPN polymer material may vary, and any of the formulations may be used in the method disclosed, which method may be performed by the apparatus disclosed.

The disclosed invention is one in which a combination of at least two polymer networks are formed, and at least one of the networks is cross-linked and/or synthesized in the presence of the other or others. Thus, the at least two networks are cross-linked and/or synthesized substantially simultaneously. “Substantially simultaneously” includes where one polymer network begins cross-linking and/or synthesizing prior to the completion of the cross-linking and/or synthesizing of the other polymer network or networks. Stated differently, “substantially simultaneously” includes where one polymer network and another polymer network complete cross-linking and/or synthesizing at different times and at about the same time.

The method may be carried out by a low-cost, dual syringe orthogonal reactive mixture (ORM) technique that 3D prints an alginate-polyacrylamide IPN hydrogel solution into tissue-scale geometries with tunable, tissue-mimetic elastic and viscoelastic mechanical properties. Since only orthogonal components are stored together, the dual syringe ORM technique permits reactive mixing to occur only immediately before extrusion, thereby increasing the control of reaction kinetics. Thus, the technique may 3D print other IPN and double network hydrogel materials with complex orthogonal reactive groups, as described below.

Several 3D printed IPN polymer material constructs have been made in various shapes and sizes. Volumes of printed constructs have been measured and compared to input solution volumes. Mechanical tests of printed constructs have been carried out. Hydrogel materials, like the alginate-polyacrylamide interpenetrating network (IPN) hydrogel described herein, are of most interest as soft tissue analogues due to their ability to mimic both the elastic and viscoelastic behaviors of biological soft tissues.

A dual syringe orthogonal reactive mixture technique for 3D printing of centimeter scale constructs from complex, tunable IPN hydrogel materials is disclosed. The technique is compatible with low cost hardware and software components, allowing for increased availability. It can produce tissue-mimetic structures with good shape fidelity. These constructs not only have stiffness properties similar to biological soft tissue, but can also be tuned to display increased amounts of stress relaxation behavior. Stress relaxation is an important consideration in the mechanical relevance of medical simulators because native tissues display viscoelastic behavior under sustained loading conditions similar to those that may occur in simulated surgical procedures. The print speed is an additional attribute to the system as it exceeds traditional bioplotting systems and is competitive with other groups using the Fab@Home printer. The dual syringe ORM technique disclosed herein allows materials with increasing complexity and mechanical relevance to be printed rapidly, accurately, and affordably, thus offering significant potential to advance medical simulation or other biomedical applications.

### BRIEF DESCRIPTION OF THE SEVERAL VIEWS OF THE DRAWINGS

FIG. 1 is a schematic side view in perspective illustrating the adapted printer.

FIG. 2 is a schematic end view in perspective illustrating the adapted printer.

FIG. 3(a) is a schematic side view illustrating two syringes with the reactive components separated to prevent early gelling.

FIG. 3(b) is a schematic side view illustrating a static mixing head showing that the reaction between GDL and CaCO₃ begins forming ionic crosslinks between the alginate chains during mixing.

FIG. 3(c) is a schematic side view illustrating the final hydrogel network with covalent crosslinks formed from UV-induced radical initiation of Irgacure 1173.

FIG. 4 is a flow diagram illustrating the software processing that was performed. Programs are boxed, and file-types are indicated over the arrows, and manual processing is denoted “M.P.”

FIG. 5A is a schematic view in perspective illustrating the print path on the z-axis. Slic3r software allows for the path used by the printer to be set.

FIG. 5B is a schematic side view illustrating the print path in section.

FIG. 6 is a table showing the results of unconfined compression stress relaxation tests (10 sec at 1% strain sec⁻¹ ramp, 500 second hold) according to variations in MBAA on samples made according to the present invention and compared to muscle tissue.

FIG. 7 is a table showing the percent monomer as compared against selected elastic moduli from literature for skin/subcutaneous tissue, skeletal muscle, and cardiac muscle.

FIG. 8 is a table showing the mean fracture energy of 68.5±5.9 Jm⁻² for the optimized formula without solvent, and 496.5±179.4 Jm⁻² for the same formula after 72 hours submerged in 0.3M CaCl² solution.

FIG. 9 is a schematic illustrating numerous monomers, including a preferred acrylamide monomer, many of which could be substituted for a preferred monomer in one of the polymer networks of an IPN polymer material.

FIG. 10 is a schematic illustrating other monomers, which could be substituted for the preferred monomer in one of the polymer networks of an IPN polymer material

FIG. 11 is a schematic illustrating other chemical cross-linkers, including a preferred N, N′-methylenebisacrylamide (MBAA), many of which could be substituted in one of the polymer networks instead of the preferred cross-linker.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application Ser. No. 62/242,490, which is the above claimed priority application, is incorporated in this application herein by reference.

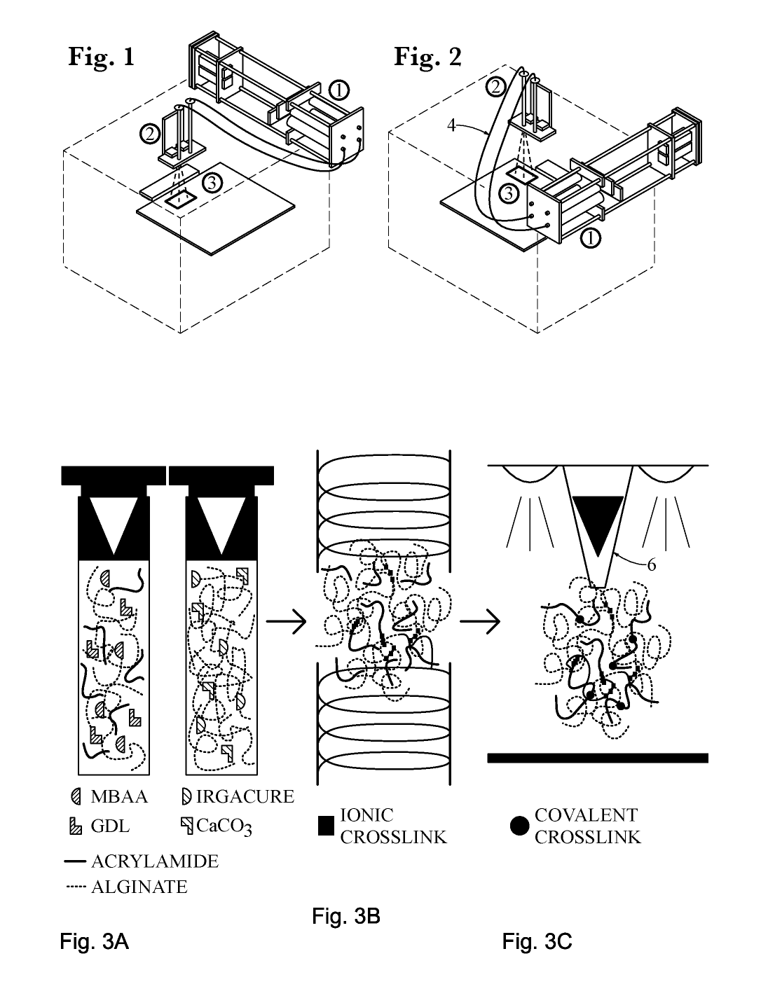

FIG. 1 shows an apparatus that may be used to print an IPN hydrogel material using a dual-syringe orthogonal reactive mixture (ORM) technique. The hardware and software of a commercially available 3D printer platform (e.g., Fab@Home Model 3 Research Platform, Seraph Robotics Inc.) were modified to accommodate IPN synthesis. The conventional printer uses a print head that is slidably mounted along the length of a beam. The beam is slidably mounted near the beam's ends to a pair of spaced parallel rods, which rods are perpendicular to the beam. The beam slides along the length of the parallel rods. A nozzle that dispenses liquid is mounted to the print head. The head may be moved longitudinally along the beam, and the beam may be moved longitudinally along the rods, in a conventional manner by electro-mechanical, electro-pneumatic or other transducers and as controlled by a computer. Furthermore, the head may be moved vertically, which is perpendicular to both the beam and the rods. This mechanism locates the nozzle at a precise (x,y,z) location above a substrate, and moves the nozzle to other locations above the substrate, whereby a material may be dispensed in thin layers from the nozzle onto the substrate, thereby building up the material on the substrate to form the three-dimensional object. The building up of the material may take place in a layer-by-layer manner, whereby a first layer is extruded upon the substrate, the print head (and nozzle) is raised, and then another layer is extruded onto the first layer at a slightly higher position above the substrate. Of course, it is contemplated that the substrate may move along x, y and z axes and the print head may be stationary, or a combination.

An external extrusion tower 1 was designed and built to hold up to four 60cc syringes to replace the syringes on the conventional 3D printer. Each pair of the four syringes is depressed using a single motor so that a 1:1 ratio of liquid is dispensed from each pair of syringes. Of course, individual motors for each syringe are contemplated but would increase cost. Furthermore, any number of syringes or other dispensing containers may be used to contain the reactive components of the IPN polymer material and any additives, and each such container may be acted on in a conventional manner to convey the contents thereof to where the pre-reaction contents of the IPN polymer material are mixed. The motor may displace the material in the syringes at a rate of about 0.27 cubic centimeters per minute.

Flexible tubing, which may have an inner diameter of one-half inch, extends from each syringe to a static mixing head 2, which is shown schematically in FIG. 3(b). The static mixing head 2, which may be substituted by any receptacle in which mixing of the components of the syringes may occur, is thus fluidically connected with the syringes. The mixing head may be a Fisnar device that is 149 mm long with a 5.0 mm inner diameter and 24 mixing elements, and may have an inner volume of between 2.5 and 3.0 cubic centimeters. The mixture of the components may have a dwell time in the mixing head 2 of between about 9 and 11 minutes.

To accommodate the mixing head 2, the original printer carriage is preferably replaced with a custom carriage 4, which houses six UV LED lights 5 adjacent the nozzle 6, which is mounted in fluid communication to the end of the mixing head 2, to initiate the free radical polymerization that crosslinks the acrylamide network. The proximity of the lights 5 to the nozzle 6 is shown schematically in FIG. 3(c). This design facilitates printing 120 cm³ constructs, compared to 10 cm³ for the stock printer, within the 23×12.8×20 cm (x/y/z) build space. Of course, other printers with other spaces and sizes are contemplated, as will be apparent to the person of ordinary skill from the description of the invention.

FIG. 3 depicts schematically the synthesis reactions during printing and how they relate to the printer hardware. The alginate-polyacrylamide IPN polymer hydrogel material requires mixing of two orthogonal reactive mixture (ORM) solutions prior to extrusion from the nozzle 6, as shown contained in the two syringes in FIG. 3(a). Two solutions may be made in which the GDL and CaCO₃ are separated, and the Irgacure 1173 is separated from the MBAA and acrylamide to prevent gelling prior to mixing. This separation is illustrated schematically in FIG. 3(a) where GDL, MBAA and acrylamide components are shown in the left syringe, and Irgacure 1173, CaCO₃ and alginate are shown in the right syringe.

By placing one component in one syringe and the other component in the other syringe, no polymer networks of the subsequently-formed IPN polymer material can begin forming until the two components are physically combined in the static mixing head 2, which subsequently extrudes the mixture through the nozzle 6, preferably in a thin layer. The mixture is extruded onto a substrate (which is the table of the 3d printer for the first layer of material, but then is the prior layer of dispensed material for every subsequent layer) in the shape that is programmed into the computer that operates the 3D printer in a conventional manner. The operation of the 3D printer may be conventional as to the manner by which the nozzle that dispenses the mixture is guided, and by which the quantity of liquid is dispensed.

The mixing head 2 combines (FIG. 3(b)) the fluent materials directly prior to extrusion (FIG. 3(c)) onto the substrate. During the residence time in the mixing head 2, which may be measured in minutes, ionic crosslinks begin to form between the alginate and the Ca²⁺ that is released from CaCO₃ as gluconolactone (GDL) hydrolyzes. Upon extrusion (FIG. 3(c)), the 365 nm UV light cast by the lights 5 decomposes the photo-initiator, Irgacure 1173, which starts the free radical polymerization of the covalently crosslinked polyacrylamide network. The UV lights 5 are mounted directly adjacent the extrusion nozzle 6 so that the UV light is cast directly onto the nozzle 6 and the region directly below the nozzle 6 during extrusion. The lights 5 are preferably spaced evenly and circumferentially around the nozzle 6. The extrusion nozzle 6 may be polyethylene with a UV light-blocking additive that prevents light from reaching the mixture until the mixture is dispensed out of the nozzle. The UV light impacts the mixture immediately upon extrusion from the mixing head 2 so that the cross-linking and/or synthesis of the second polymer network (polyacrylamide, in the embodiment described above) begins.

Thus, the alginate (ionic) portion of the network is ionically crosslinked using a system of calcium carbonate (CaCO₃) paired in a 1:2 molar ratio with D-glucono-δ-lactone (GDL). Calcium is generated in the reaction mixture, and the calcium cross-links acid groups on the alginate polymer. The calcium ions are released slowly, which controls gelling time. The acrylamide monomer is covalently crosslinked using N, N′-methylenebisacrylamide (MBAA) and the reaction is initiated using Irgacure 1173 under four 365 nm UV lights arranged in an array around the print nozzle. The preferred intensity of the UV light is about 20 mW/cm².

By casting UV light on the mixture as it is extruded, the cross-linking of the second polymer network is initiated as the mixture is extruded, which is at a time when the first polymer network has not completed its cross-linking due to the controlled release of the calcium ions. Thus, while the mixture is being extruded onto the substrate and subsequently, both polymer networks of the IPN are forming simultaneously in the already-dispensed liquid. This is important due to the critical nature of 3D printing. In a 3D printing situation, there is a requirement balancing the liquid's viscosity between the two extremes of flowing too much and not flowing enough. When extruding or otherwise dispensing liquid, there is a need to ensure that the material flows sufficiently so that it can pass through the orifice. Thus, the liquid must flow enough before it polymerizes fully, because after complete polymerization it may not flow through the orifice. However, if the liquid flows too much, it may pool rather than holding its shape prior to complete polymerization. The problem of this balance is magnified when one combines two materials that form two or more polymer networks. In the present invention, at least one of the two polymer networks begins to form upon mixing the two previously-separated components. The viscosity of such a liquid can change as the liquid is displaced through the mixing head and extruded from the nozzle. With the formation of the second and subsequent polymer networks, the viscosity may change further. To begin forming an IPN just before extruding the mixture of the previously-separated components thereof to a 3D printer means the mixture changes viscosity as it is being dispensed.

In the prior art the manner in which two separate materials were combined to form an IPN was not relevant, because the networks were formed in a static situation. But with 3D printing there are various parameters, such as viscosity, that are crucial in order that 3D printing can occur. Viscosity affects the factors discussed above, including flowing through the nozzle and flowing once extruded and resting upon a surface. If the fluid flows too much, then the shape will not be retained by the time both polymer networks are fully formed. If the fluid flows too little, then the fluid cannot be extruded through an orifice made for a lower viscosity liquid. The timing of the cross-linking is crucial.

A range of the components of a formulation are given, which components may be combined as described above or as the person of ordinary skill will understand from the description herein. A preferred formulation for 3D printing contains about 1.0 to 4.0 wt % alginate; 14.0 to 20.0 wt % acrylamide; 0.0 to 40.0 wt % GDL plus CaCO₃ with respect to the weight of alginate; 0.004 to 1.0 wt % MBAA with respect to the weight of acrylamide; 0.2 to 5.0 wt % Irgacure 1173 with respect to the weight of acrylamide; and the remainder de-ionized water. A more preferred formulation for 3D printing contains about 2.0 to 3.0 wt % alginate; 15.0 to 18.0 wt % acrylamide; 10.0 to 20.0 wt % GDL plus CaCO₃ with respect to the weight of alginate; 0.1 to 0.8 wt % MBAA with respect to the weight of acrylamide; 1.5 to 3.0 wt % Irgacure 1173 with respect to the weight of acrylamide; and the remainder de-ionized water. The most preferred formulation for 3D printing contains about 2.5 wt % alginate; 17.5 wt % acrylamide; 15 wt % GDL plus CaCO₃ with respect to the weight of alginate; 0.6 wt % MBAA with respect to the weight of acrylamide; 2.3 wt % Irgacure 1173 with respect to the weight of acrylamide; and the remainder de-ionized water. All of the above formulations were used in the method and apparatus disclosed herein, and produced suitable IPN polymer materials. Of course, the preceding quantities and ratios may vary, as the person of ordinary skill will understand, with variations in characteristics of the resulting IPN polymer material. For example, the tactile properties of the resulting IPN polymer materials were found to be largely affected by the concentration of MBAA and the GDL/CaCO₃ system. Thus, various formulations were tested having between 2.0 and 25.0 wt % GDL/CaCO₃ of the total weight of alginate in the formulation. The gel time varied between 6 minutes and well over 24 hours.

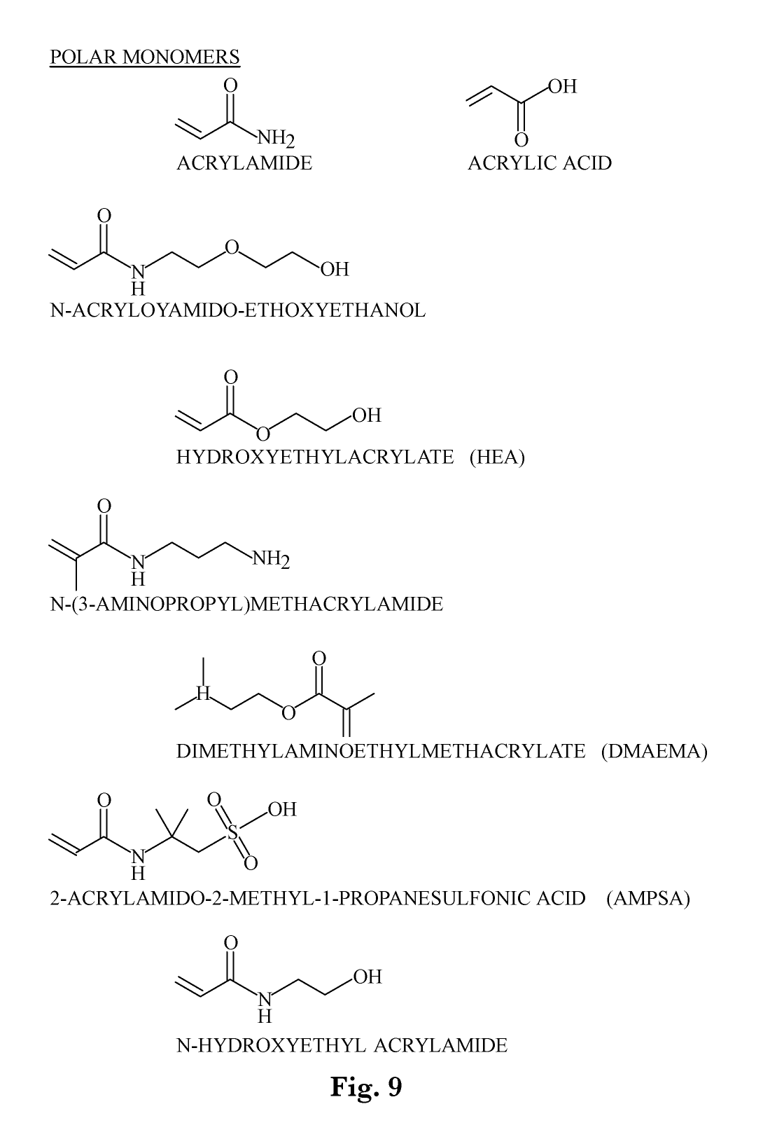

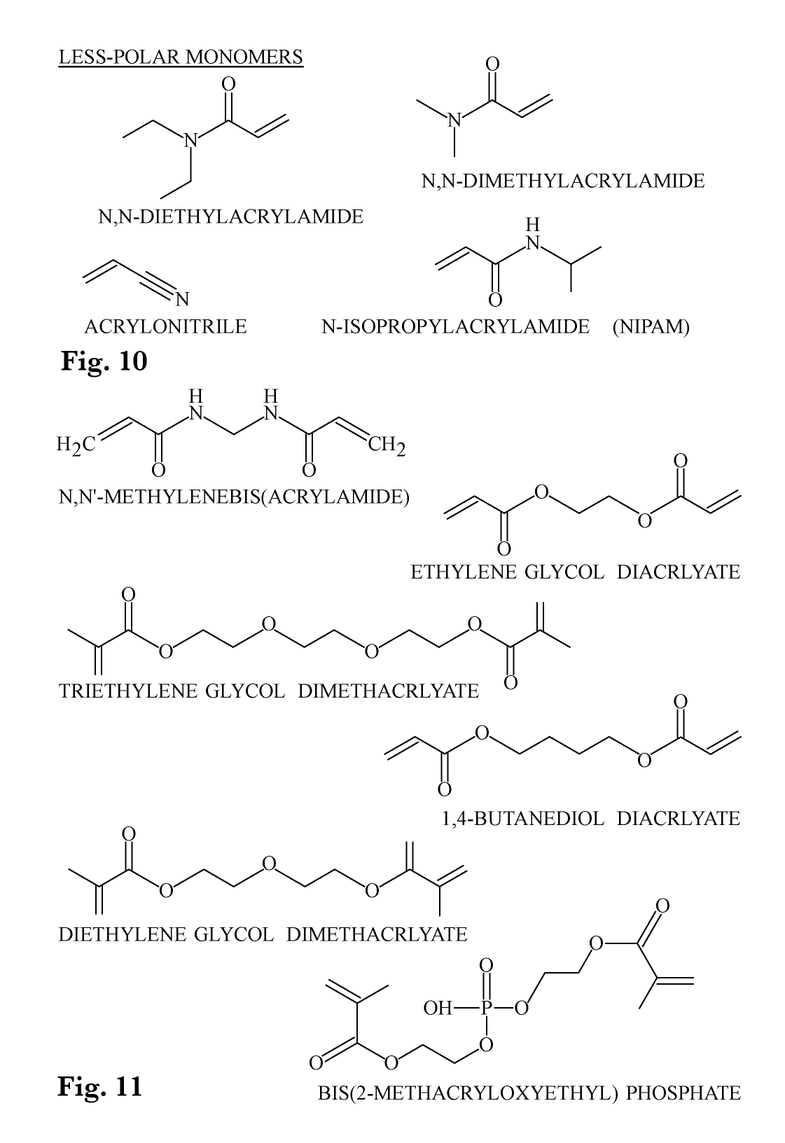

The IPN polymer material that results from the above formulations has a covalently-linked acrylamide network and an ionically-linked alginate network. The cross linking of the former is initiated using UV light, and the cross-linking of the latter is initiated by the chemical reaction described herein, which chemical reaction progresses in a predictable manner that permits extrusion prior to completion of the cross-linking. Applicants contemplate other networks that could substitute for the two preferred networks described herein. For example, FIG. 9 shows numerous polar monomers that could be substituted for the covalent (acrylamide) network. This can be done readily to modify how the acrylamide functions. FIG. 10 shows some less-polar monomers that could also be substituted for the covalent network. FIG. 11 shows chemical cross-linkers that could be used in the covalent network instead of N, N′-methylenebisacrylamide (MBAA).

Calcium cations (Ca²⁺) crosslink the alginate (ionic) portion of the IPN network. Other candidate cations that could be substituted for calcium include strontium (Sr²⁺), barium (Ba²⁺), aluminum (Al³⁺), and iron (Fe³⁺). It is also contemplated to replace the entire alginate network with other polymers that have cross-linking times that progress in a manner that permits them to be extruded prior to achieving a viscosity that prevents or inhibits extrusion through a nozzle with an orifice. Gelatin could be used instead of the alginate network in the network of an IPN hydrogel. For example, hydrolyzed collagen is suitable for use in a mixture that is extruded at elevated temperatures sufficient to achieve desirable viscosities and that gels controllably upon cooling after extrusion. Sulphated polysaccharides, such as carrageenans, may be used similarly in a liquid that is extruded at higher temperatures and that gels controllably upon cooling. Other reactive polymer chemistries are also known, such as the azide/alkyne “click” chemistries, and the thiol-ene/thiol-yne reaction. All of these are suitable for use.

With the alginate and acrylamide networks described herein, there are two polymer networks in the IPN. However, the invention includes having third, fourth and more polymer networks. In the preferred embodiment, the reactive components that are required for the polymerization of each network are separated into two syringes. Because of this, the preferred printing process is referred to herein as the “dual-syringe ORM” technique, process or method. The solutions in each of the syringes preferably have similar viscosities to ensure a 1:1 mixing ratio due to the use of a single motor to dispense both syringes simultaneously. A similar viscosity exists according to the invention where a viscosity, which may be determined using a viscometer, of a first solution in a first syringe is within (i.e., plus or minus) 20% of the viscosity of the second solution in the second syringe. For the dual syringe ORM method, the viscosity of the syringe fluids can be relatively low compared to other printing platforms. This allows for a single motor to push both syringes while maintaining control of gel formation. The ability to print with relatively low viscosity fluids (3,000 cP) using the dual syringe ORM method avoids the need for expensive pneumatic drivers and allows the use of more affordable printer platforms for rapid IPN hydrogel model fabrication.

In the preferred formulation the viscous alginate has the largest impact on viscosity and is preferably distributed into both syringes to achieve the desired balance. Of course, if one uses one motor or other prime mover on each syringe to pump liquid from the syringes into the mixing head separately, viscosities may vary more without adverse effect. The preferred motor (Snap Motors 62:1) used in the experiments has a maximum limit of about 10,000 centipoise (cP), and the desired viscosity for printing the materials described is about 3,000 cP because this avoids the use of expensive pneumatic drivers. More than two syringes may be used, particularly if more and/or optional components are desired, as will become apparent to the person of ordinary skill from the disclosure herein.

Using the dual syringe ORM method for alginate-polyacrylamide IPN polymer hydrogels, simple geometries were 3D printed with a high degree of accuracy (average of 7.9% deviance from desired geometry) at a print speed of 258 mm³ min⁻¹. Thus, a 2×2×2 cm cube can be printed in about 31 minutes.

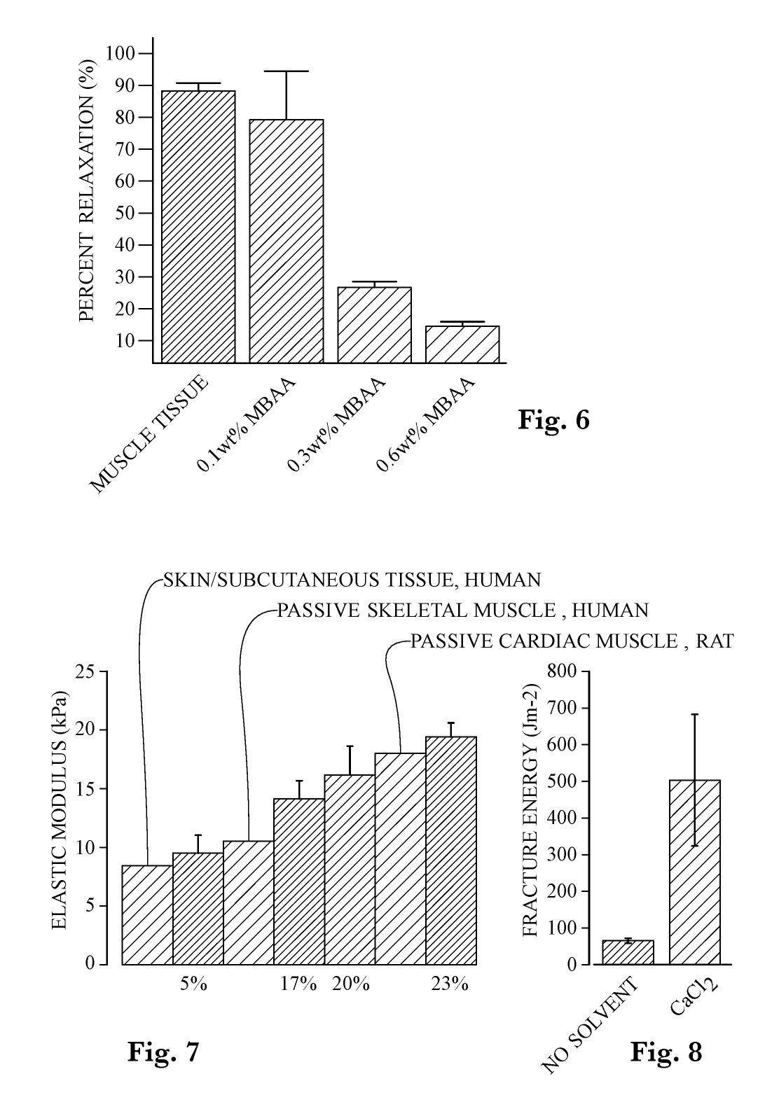

The realism of medical simulators is enhanced by a model's ability to accurately mimic native tissue mechanical properties. Thus, it is desirable that the elastic modulus and viscoelasticity (quantified by percent of stress relaxation) of the 3D printed construct be in a range that approximates native tissue. Applicants performed ramp-hold compression tests on samples made using the formulations, methods and apparatuses disclosed herein, and the results are shown in FIGS. 6 and 7. These show that the viscoelastic stress relaxation of the 3D printed IPN gels can be tuned by changing the concentration of MBAA in the solution (see FIG. 6). Results in FIG. 6 are compared to porcine muscle tissue, as shown. Decreasing the concentration of MBAA to 0.1 wt % with respect to acrylamide increases its relaxation dramatically so that it mimics the viscoelasticity of porcine muscle tissue (FIG. 6). However, as the concentration of MBAA decreases from the optimal (shape fidelity) value of 0.6 wt % with respect to acrylamide, the shape fidelity of the print declines due to fewer covalent crosslinks holding the material together. As the number of covalent crosslinks decreased, the shape fidelity decreased while the stress relaxation increased. The elastic (Young's) modulus of the 3D printed construct, obtained from the ramp phase of compression testing, can be tuned through varying the total percent monomer (FIG. 7). Results are shown for the optimized formula, with changes only in MBAA concentration (FIG. 6) or total monomer concentration (FIG. 7) as shown.

Fracture energy is a mechanical metric acquired from tensile testing and used to understand the failure properties of hydrogels. This was calculated during testing from tensile tests on printed rectangular samples, 2×25×12 mm. Matched tensile tests were conducted on both intact and notched samples. Fracture energy of similar hydrogels has been previously shown to increase with soaking of samples in divalent ions. The fracture energy of the preferred 3D printed hydrogel material is initially modest, with a mean value of 68.5 J/m². However, soaking the material in 0.3 M CaCl₂ for 72 hours before being tested increased the fracture energy by 625% to a value of 496.5 J/m² (FIG. 8). Although this technique allows for the material to become tougher, the stress relaxation behavior may significantly decrease after soaking.

Opacity of the 3D printed IPN gels was investigated as a function of the initiator concentration (Irgacure 1173, BASF, Greenville, Ohio). An increase in opacity was observed with higher concentrations of the Irgacure 1173, making it a chemically tunable parameter. Since Irgacure 1173 is only sparingly soluble in water, this may be due to highly crosslinked or water insoluble domains formed within the network. The additional layers required for the larger constructs cause even the 2.3 wt % concentration, as in the optimal formulation, to appear completely opaque.

Although anatomical structures must have high shape fidelity to be used in medical simulation, the shape fidelity of complex anatomical structures is often difficult to quantify accurately. Printing of simpler geometric shapes allows for any deviation in the constructs between the ideal and the printed geometry to be easily seen and analyzed. The shape fidelity of the printed constructs was quantified by printing cubes and cylinders with the optimal formula. A cube of side length 20 mm was printed, then analyzed using Image J software to determine its deviance from the expected geometry. This analysis procedure included making masks of the ideal dimensions for each side of the cube (20 mm×20 mm), one mask for overfill and another for undershoot. The masks were applied to the images, each image was converted to binary in Image J, and the resulting areas were measured. The same procedure was followed to analyze the optimized cylinder (25 mm dia.×20 mm height). Shape fidelity depends strongly on material formulation, as noted above. For the optimized formula, the technique developed was able to create printed geometries with an average deviance of only 7.9% across the entire shape.

An anatomical model of a heart was 3D printed based on geometry from an open-source CAD file of the human heart (GrabCAD, Cambridge, Mass.). The elastic modulus of the print was tuned to mimic normal cardiac muscle; the stress relaxation of the print was not tuned, so that optimal shape fidelity could be maintained. The print was constructed using the alginate-polyacrylamide IPN material formula optimized for elastic modulus and shape fidelity. The elastic modulus of the printed material was 16.2±2.5 kPa, similar to that reported for normal cardiac muscle (18±2 kPa). The ability to 3D print an anatomical shape with mechanical properties tunable to native tissues shows promise for the use of 3D printed IPN hydrogels in medical simulation devices.

Ramp-hold compression testing was performed (Bose Electroforce 3200 Series III, Eden Prairie, Minn.) with a ramp rate of 1% strain sec-1 to a final strain of 10%. The hold period at 10% strain was 500 seconds. Tensile testing was performed (Instron 3344, Norwood, Mass.) at a rate of 0.1% strain per second until failure, or critical stretch, was reached. Testing was done on samples not placed in a solvent and samples soaked in 0.3M CaCl₂ for 72 hours. Tests were performed at 50% humidity.

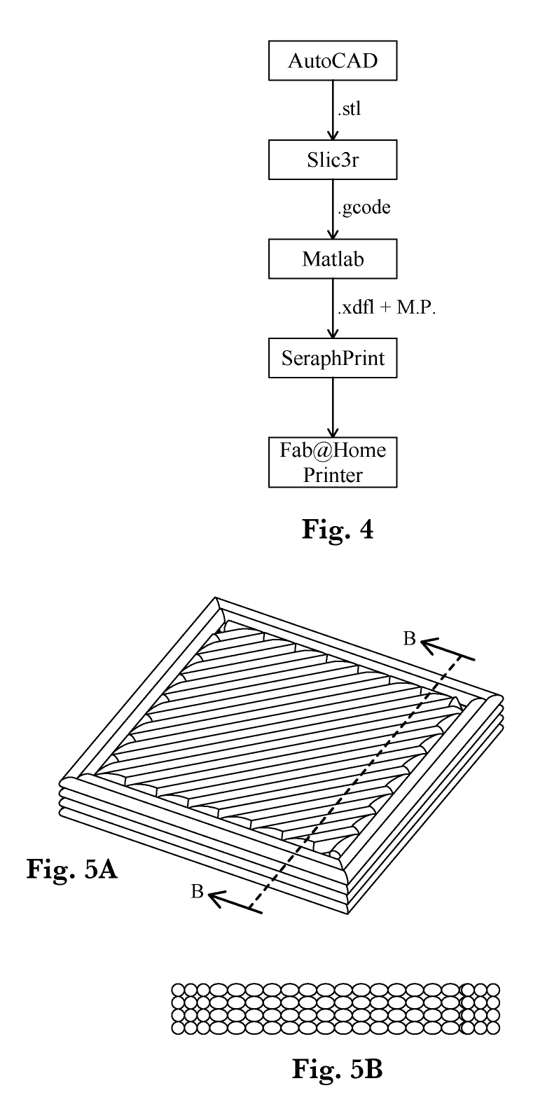

It was necessary to modify the printer control software from the stock software and to develop custom code to accommodate the extensive hardware modifications. FIG. 4 shows the software processing procedure. FIG. 5A shows the fill pattern (the path of the print head) and FIG. 5B shows a cross-sectional view of the internal structure generated by the fill pattern. Printer resolution ranged from 780 to 1200 microns.

Three-dimensional geometries, such as those obtained from computer aided design (CAD) software can be assembled and used to generate .stl (Standard Tessellation Language) files, which provide control over scaling and printable geometry. The .stl files are imported to the program Slic3r (developed by Alessandro Ranellucci, GNU Affero General Public Liscense, version 3), which generates print paths as a string of x, y, and z coordinates based on the print parameters that are specified by the user from knowledge of the print material's properties. Several new variables are introduced into the coding with the SeraphPrint software and are set in Slic3r using similar parameters.

Print parameters available for manipulation in Slic3r include path height, path width, fill pattern, and fill density, among others. The fill pattern determines the way in which the material is laid down during printing. A rectilinear fill pattern was used for this material (FIG. 5A). Consecutive layers of the same pattern are extruded on top of one another while alternating starting points allowing for the consecutive layer patterns to be perpendicular to each other. A cross sectional cut of the layers gives a view of the internal structure of the printed object (FIG. 5B).

Differences in the single-line print resolution for changing values of area constant (AC) were investigated via image analysis. AC is a Seraph-defined parameter that relates the depressor distance traveled to the volume that is extruded by the syringes. To quantify printer resolution for the IPN material, single line prints were deposited on a glass cover slip and allowed to remain under UV light for approximately 30 seconds after printing for completion of the polymerization reactions. Images were obtained using a light microscope and hemocytometer grid, and line widths were quantified in Image J. Nozzle width was 0.41 mm for all trials. Results show that the AC printer parameter strongly impacts single-line print resolution, with optimal performance at AC=0.185 yielding a line width of 0.78±0.04 mm.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of forming an interpenetrating network (IPN) polymer material, the method comprising:
(a) displacing a first liquid from a first container into a receptacle;
(b) displacing a second liquid from a second container, which second liquid in the second container is not in contact with the first liquid, into the receptacle;
(c) mixing the first and second liquids in the receptacle to cause previously-separated components in the first and second liquids to cross-link and/or synthesize at least a first polymer network of the IPN polymer material;
(d) dispensing the mixture of the first and second liquids from the receptacle to a substrate prior to complete cross-linking and/or synthesis of the first polymer network; and
(e) applying an input to the mixture of the first and second fluids prior to complete cross-linking and/or synthesis of the first polymer network, thereby initiating cross-linking of at least a second polymer network of the IPN polymer material substantially simultaneously with cross-linking and/or synthesis of at least a portion of said at least a first polymer network.

2. The method in accordance with claim 1, wherein the step of dispensing further comprises extruding the mixture of the first and second fluids through a nozzle in vertically-overlapping layers on the substrate.

3. The method in accordance with claim 2, wherein the step of applying an input further comprises directing ultraviolet (UV) light onto the mixture of the first and second fluids as the mixture is extruded from the nozzle.

4. The method in accordance with claim 1, wherein:
(a) the step of mixing further comprises forcing the first and second liquids through a static mixing head;
(b) the step of dispensing further comprises extruding the mixture of the first and second liquids from the static mixing head through a nozzle; and
(c) the step of applying an input further comprises directing electromagnetic radiation onto the mixture of the first and second fluids as the mixture is extruded from the nozzle.

5. The method in accordance with claim 4, further comprising selectively displacing a third liquid from a third syringe into the static mixing head.

6. The method in accordance with claim 4, further comprising the step of soaking the interpenetrating network (IPN) polymer material in a calcium chloride solution.

7. An apparatus for forming an interpenetrating network (IPN) polymer material, the apparatus comprising:
(a) a first container holding a first liquid and in fluid communication with a receptacle;
(b) a second container holding a second liquid and in fluid communication with the receptacle, wherein the receptacle is configured to form a mixture of the first and second liquids, thereby causing previously-separated components in the first and second liquids to cross-link and/or synthesize at least a first polymer network of the IPN polymer material;
(c) a nozzle in fluid communication with the receptacle and through which the mixture of the first and second liquids is extruded prior to complete cross-linking and/or synthesis of the first polymer network;
(d) at least one electromagnetic radiator mounted adjacent the nozzle to radiate energy onto the mixture of the first and second fluids as the mixture is extruded from the nozzle and prior to complete cross-linking and/or synthesis of the first polymer network, thereby initiating cross-linking and/or synthesis of at least a second polymer network of the IPN polymer material substantially simultaneously with cross-linking and/or synthesis of at least a portion of said at least a first polymer network; and
(e) a substrate mounted beneath the nozzle and onto which the mixture of the first and second liquids is extruded.

8. The apparatus in accordance with claim 7, wherein said at least one electromagnetic radiator further comprises a plurality of ultraviolet lights.

9. The apparatus in accordance with claim 7, further comprising a third container holding a third liquid and fluidically connected to the receptacle.

10. The apparatus in accordance with claim 7, wherein the first and second containers are first and second syringes.

11. A formulation for forming into an interpenetrating network (IPN) polymer material, the formulation comprising
(a) about 1.0 to 4.0 wt % alginate;
(b) about 14.0 to 20.0 wt % acrylamide;
(c) about 0.0 to 40.0 wt % GDL plus CaCO₃ with respect to the weight of alginate;
(d) about 0.004 to 1.0 wt % MBAA with respect to the weight of acrylamide;
(e) about 0.2 to 5.0 wt % Irgacure 1173 with respect to the weight of acrylamide; and
(f) a remainder water.

12. The formulation in accordance with claim 11, wherein the formulation further comprises:
(a) about 2.0 to 3.0 wt % alginate;
(b) about 15.0 to 18.0 wt % acrylamide;
(c) about 10.0 to 20.0 wt % GDL plus CaCO₃ with respect to the weight of alginate;
(d) about 0.1 to 0.8 wt % MBAA with respect to the weight of acrylamide;
(e) about 1.5 to 3.0 wt % Irgacure 1173 with respect to the weight of acrylamide; and
(f) a remainder water.

13. The formulation in accordance with claim 12, wherein the formulation further comprises:
(a) about 2.5 wt % alginate;
(b) about 17.5 wt % acrylamide;
(c) about 15.0 wt % GDL plus CaCO₃ with respect to the weight of alginate;
(d) about 0.6 wt % MBAA with respect to the weight of acrylamide;
(e) about 2.3 wt % Irgacure 1173 with respect to the weight of acrylamide; and
(f) a remainder water.
